(19) United States
(12) Patent Application Publication
(10) Pub. No.: US 2019/0042071 A1
(43) Pub. Date: Feb. 7, 2019

(54) CONTEXTUAL EXPERIENCE BASED ON LOCATION

(71) Applicant: Microsoft Technology Licensing, LLC, Redmond, WA (US)

(72) Inventor: Dhiraj Pramod GANDHI, Redmond, WA (US)

(21) Appl. No.: 15/670,555

(22) Filed: Aug. 7, 2017

(51) Int. Cl. G06F 3/0481; H04L 29/08; H04W 4/18; H04W 4/00; H04W 4/02; G06N 99/00

(52) U.S. Cl. CPC G06F 3/04817; H04L 67/22; G06N 99/005; H04W 4/001; H04W 4/025; H04W 4/185

(57) ABSTRACT

A digital assistant supported on a local device and/or a remote digital assistant service is disclosed herein. The digital assistant can monitor context data associated with the user, such as prior usage patterns on the device and location data. Using the context data, the digital assistant identifies and selects relevant icons for the user and prominently displays those icons on the user's display for easy and seamless access. The digital assistant may identify icons based on intelligent predictions about the user. Furthermore, the digital assistant may adjust system resources and capabilities based on the context. For example, if the device is low on battery charge then the digital assistant can suppress or filter certain, less-important applications and functions, and identify and display relevant or critical icons to the user. This way the device saves resources and still provides a tailored user experience.

### BACKGROUND

Computing devices such as smartphones and tablets are typically configured with graphical elements, such as icons and the like, on their graphical user interfaces (GUI), which can be used to launch a variety of applications for device users.

### SUMMARY

A digital assistant supported on a computing device such as a smartphone, tablet, personal computer (PC), wearable device, media player, and the like is configured to automatically select and display graphical elements associated with applications, such as icons, and manage device resources responsively to monitored context data. The digital assistant may collect and analyze context data associated with the device and/or device user to select and display application icons on the device GUI that are relevant to a current context to enhance utility for the user. The context data can be collected using, for example, device sensors, application data, and monitored patterns of application usage by the user at different times of the day and locations. The digital assistant can select applications and system processes for execution based on context data that describes current device state (e.g., battery charge, network connectivity, processor and memory utilization, etc.), or predicted future states. The digital assistant may also be configured to selectively suppress or filter application and system processes according to current or predicted future states.

In an illustrative example, with notice to the user and user consent, the digital assistant may monitor the user's application usage associated with visits to a coffee shop to create a history. The digital assistant may monitor, recognize, and store data for a historical user pattern in which the user goes home after work, and then travels to the coffee shop to stream and watch a television show on his device. The digital assistant can employ the history to automatically download the latest or unwatched episodes of the television show while a device is connected to the Internet over the user's home Wi-Fi. This way, the user is not inconvenienced while waiting for the show to download at the coffee shop and may also save on cellular data charges, for example, if the coffee shop does provide a free Wi-Fi access point.

The digital assistant may intelligently select application icons with which the user has a history of interaction while at the coffee shop, and feature those icons on the device GUI. For example, the digital assistant may select a streaming media application (e.g., for movies/television) and the coffee shop's beverage application that provides rewards and perks for frequent customers. The current device display can be customized to the user or be configured to feature the selected icons in a contextual GUI. The user can toggle between the user-customized GUI and the contextual GUI using, for example, touch-based gestures on a touch screen, non-touch-based gestures, natural language or voice commands, or actuation of a button (e.g., real or virtual buttons) or other user controls.

In another illustrative example, the digital assistant may organize the GUI based on a state of system processes and/or resources. For example, if the device is currently low on battery charge and has a pending system update, the digital assistant can suppress the update for a later time, for example, when the device is more fully charged or plugged into an electrical outlet. If the device is operating using a cellular data connection, the digital assistant can suppress downloading the system update, for example, until the device is back on the user's low-cost Wi-Fi home network. The digital assistant may also selectively filter application icons from the GUI, or control the appearance of the GUI, based on the context. For example, the digital assistant may dim the screen, black out portions of the screen, or remove contextually-irrelevant icons from the GUI. The digital assistant can further display only contextually-relevant icons on the GUI. Such actions can conserve battery power while tailoring the GUI to improve the efficiency of the user-machine interface.

Other processes can also be suppressed or filtered based on applicable context. For example, if the user and device are in a moving car, the device's automated Wi-Fi seeking feature can be suppressed until the device is stationary. In addition, some e-mail (e.g., advertisements, junk mail, mail from unknown parties) can be filtered so that the device does not alert the user of the incoming e-mail. Thus, the digital assistant can intelligently select and display application icons, suppress application execution, and selectively filter application and system processes to proactively manage resources and enhance device functionality.

Advantageously, the digital assistant's intelligent monitoring, selection and filtering of icons and applications, enables the device operations to be optimized for a resource-efficient user experience. The digital assistant enables improvements in device operations to be realized by conserving system resources by selecting, organizing, and displaying contextually-relevant and useful icons to the user throughout the day.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure. It will be appreciated that the above-described subject matter may be implemented as a computer-controlled apparatus, a computer process, a computing system, or as an article of manufacture such as one or more computer-readable storage media. These and various other features will be apparent from a reading of the following Detailed Description and a review of the associated drawings.

### DESCRIPTION OF THE DRAWINGS

FIG. 1 shows illustrative configurations of selected graphical elements such as icons on a graphical user interface (GUI) based on context;

FIG. 2 shows an illustrative system architecture in which a GUI layer interoperates with other system layers;

FIG. 3 shows an illustrative digital assistant and local and remote optimization clients that affect icon and application management of the device;

FIG. 4 shows an illustrative taxonomy of functions performed by the optimization client of the digital assistant;

FIG. 5 shows various icon and display changes caused by the digital assistant based on context data;

FIG. 6 shows illustrative context data that may be utilized by the digital assistant;

FIG. 7 shows an illustrative process performed by the digital assistant to determine icon and application management actions;

FIG. 8 shows illustrative context data utilized by the digital assistant to determine an action;

FIG. 9 shows an illustrative GUI that exposes relevant icons based on the context data of FIG. 8;

FIG. 10 shows user feedback in response to the illustrative GUI of FIG. 9;

FIG. 11 shows illustrative context data utilized by the digital assistant to determine an action;

FIG. 12 shows an illustrative GUI and system actions based on the context data of FIG. 11;

FIG. 13 shows illustrative context data utilized by the digital assistant to determine an action;

FIG. 14 shows an illustrative GUI with relevant icons based on the context data of FIG. 13;

FIG. 15 shows an illustrative scenario in which a user walks about on streets with his tablet device;

FIG. 16 shows an illustrative street map;

FIG. 17 shows an illustrative process performed by the digital assistant based on the context data of FIGS. 15-16;

FIGS. 18-20 show illustrative processes performed by an optimization client on a local or remote device;

FIG. 21 is a simplified block diagram of an illustrative computer system such as a mobile device that may be used in part to implement the present contextual experience based on location;

FIG. 22 shows a block diagram of an illustrative device that may be used in part to implement the present contextual experience based on location; and

FIG. 23 is a block diagram of an illustrative device such as a mobile phone or smartphone.

Like reference numerals indicate like elements in the drawings. Elements are not drawn to scale unless otherwise indicated.

### DETAILED DESCRIPTION

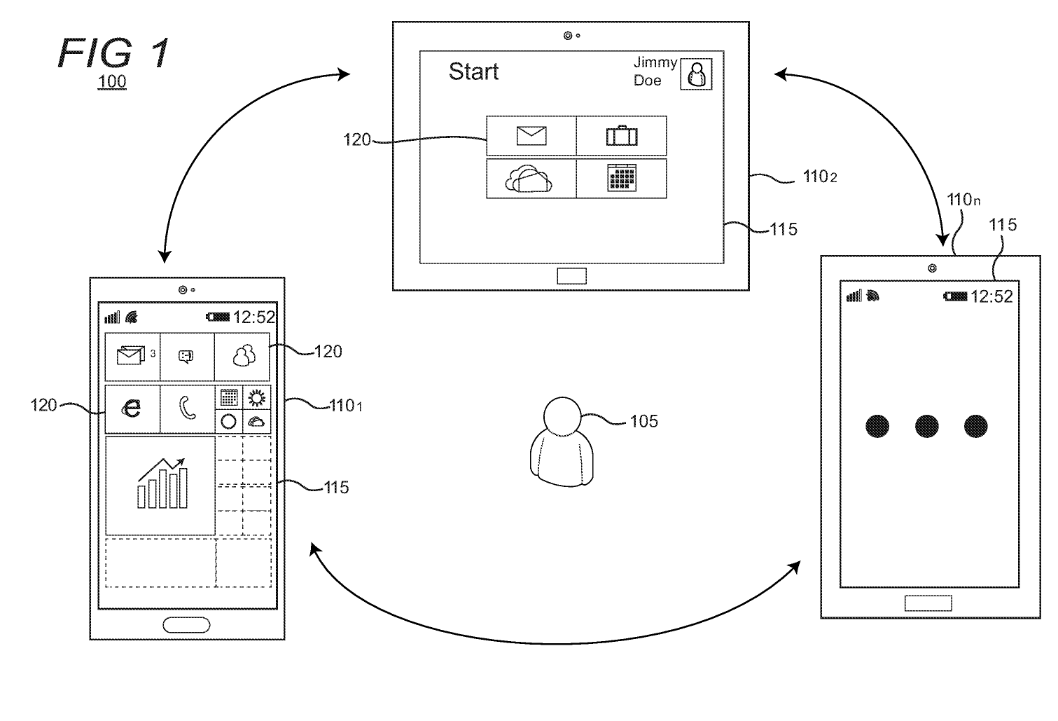

FIG. 1 shows illustrative configurations 100 of a graphical user interface (GUI) on mobile devices 110. As depicted in FIG. 1, mobile devices may include various types of smartphones and tablets. Although not shown, other types of devices may also be utilized including wearable devices such as head-mounted displays and wearable watches, laptop computers, and the like. These devices may support network connectivity and data-consuming applications such as internet browsing and multimedia (e.g., music, video, etc.) consumption in addition to various other features and applications. In addition, these devices may be used by users to make and receive voice and/or video calls, share multimedia, engage in messaging (e.g., texting) and e-mail communications, use applications, and access services that employ data, browse the World Wide Web, and the like.

For example, applications represented by graphical elements such as icons 120 across the displays 115 of devices 110 in FIG. 1 include mail, message, weather, calendar, phone, cloud accessibility, finance, video, and a digital assistant. The smartphone and tablet devices thus illustrate the various graphical elements, icons, and organization of the GUI. For example, the smartphone computer includes an array of icons that cover a majority of the area on the display. In contrast, the tablet computer includes only four icons positioned in the center of the screen. The smartphone and tablet computer may have intelligently and autonomously selected and customized the GUI of the respective displays based on current context data, as discussed in further detail below. The context data may be based on, for example, prior use patterns associated with the user 105. The final display graphically illustrates an ellipsis which represents further customizations of the displays.

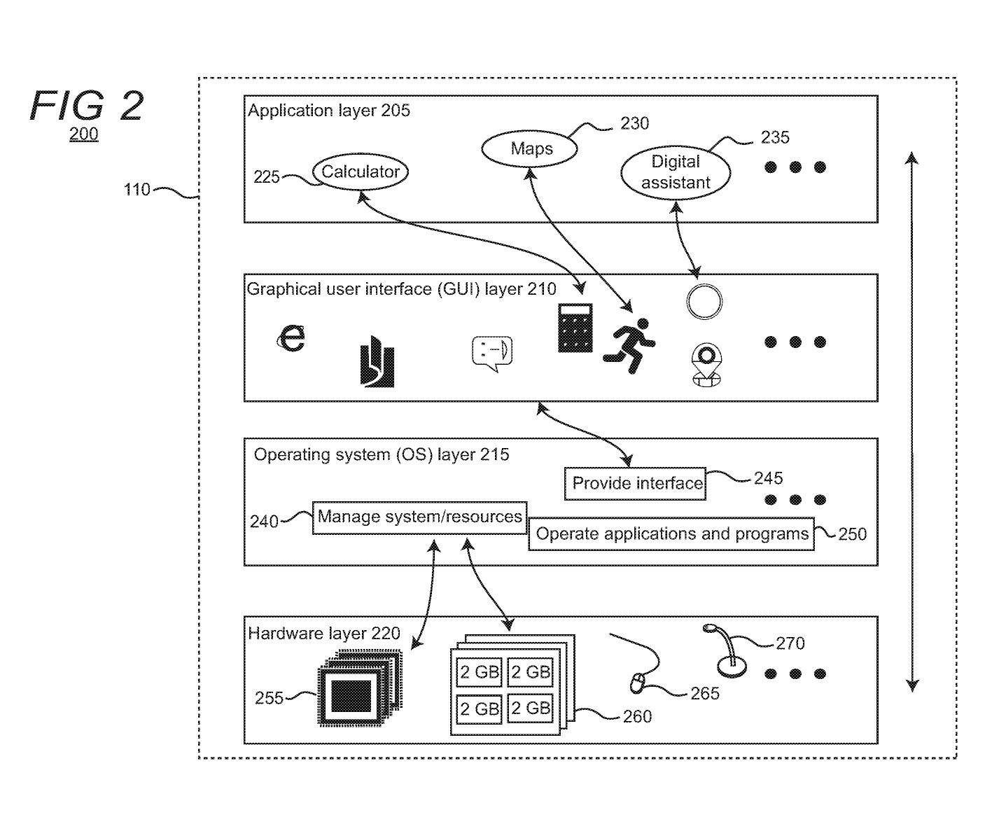

FIG. 2 shows an illustrative system architecture 200 in which the various layers of a device 110 interoperate with each other. A mobile computing device, in simplified form, may include an application layer 205, GUI layer 210, operating system (OS) layer 215, and a hardware layer 220. At the highest level, the application layer is the layer that provides various services to a user. As depicted in FIG. 2, these applications can include a calculator 225, maps 230, or digital assistant 235, although they may also include word processing applications, internet browsing, etc. The applications may coordinate with a GUI, as depicted by the GUI layer. The user may select a GUI to load a particular application, instead of utilizing a command prompt.

The applications and GUI interfaces may interoperate with the OS layer 215. The OS layer can manage systems and resources 240, provide the GUI interface 245 for the user, and operate application and programs 250. Thus, if a user selects an application, the OS layer can execute the functions and processes associated with the selected application, such as run the calculator, maps, or digital assistant. In addition, the OS layer may interoperate with the hardware layer 220 and manage the various hardware components. For example, the hardware layer can include one or more processors 255 such as central processing units (CPU) and graphic processing units (GPU), memory 260 (e.g., hard-disk drive, flash memory, etc.), and also user input/output devices such as a pointer (e.g., mouse) 265 or microphone 270. Other input/output devices not shown include a keyboard, touch screen display, and speakers.

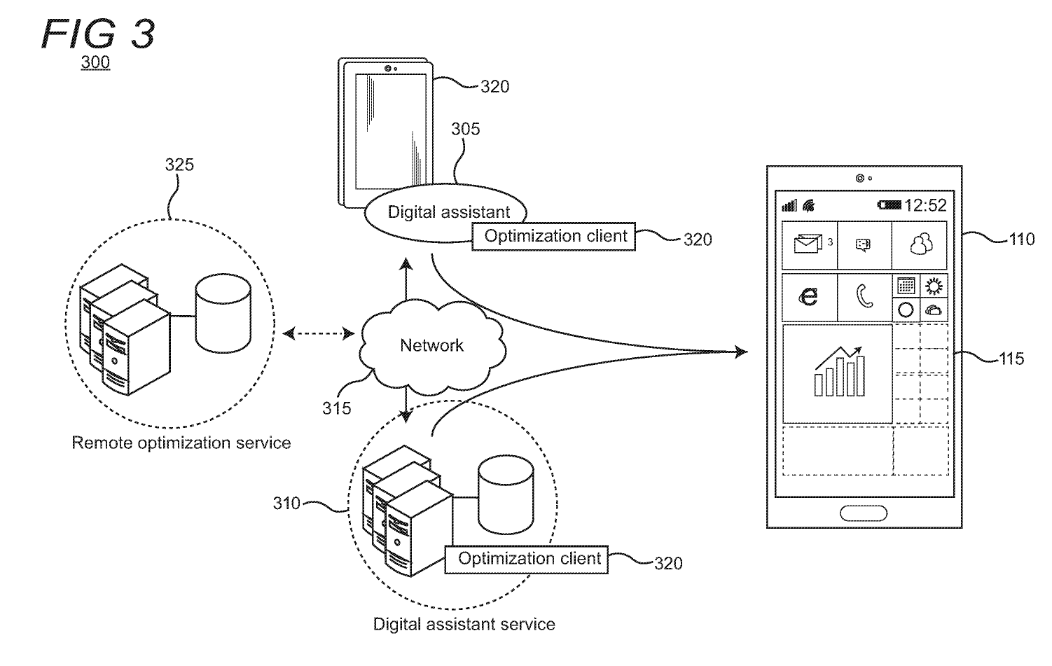

FIG. 3 shows an illustrative environment 300 of the device 110 interoperating with a digital assistant 305, which responsively or automatically selects relevant applications and icons for the display 115 of the device. The device may access the digital assistant 305 remotely, or alternatively the device may access a digital assistant service 310 over a network 315. The network 315 may include any environment that connects devices at nodes of a network, such as a personal area network (PAN), local area network (LAN), wide area network (WAN), the Internet, World Wide Web, etc. As a further example, the local digital assistant may work in combination with the digital assistant service. That is, the device 110 can utilize either or both the local and remote digital assistant services.

As further illustrated in the environment 300, the digital assistant may include an optimization client 320 that is configured to select and present relevant icons, suppress application operations, and filter application operations, all based on relevant and up-to-date context data. The optimization client may be incorporated as part of the digital assistant, such as a sub-routine or other programmatic construct that is implemented in the local or remote digital assistants.

Alternatively, the functionality of the optimization client may be separately instantiated from the device and digital assistant altogether, and operate on a remote server, as depicted by the remote optimization service 325. Therefore, discussions that describe any utilization or processes performed by the digital assistant may include any one or a combination of the local or remote digital assistants and the local or remote optimization clients or service.

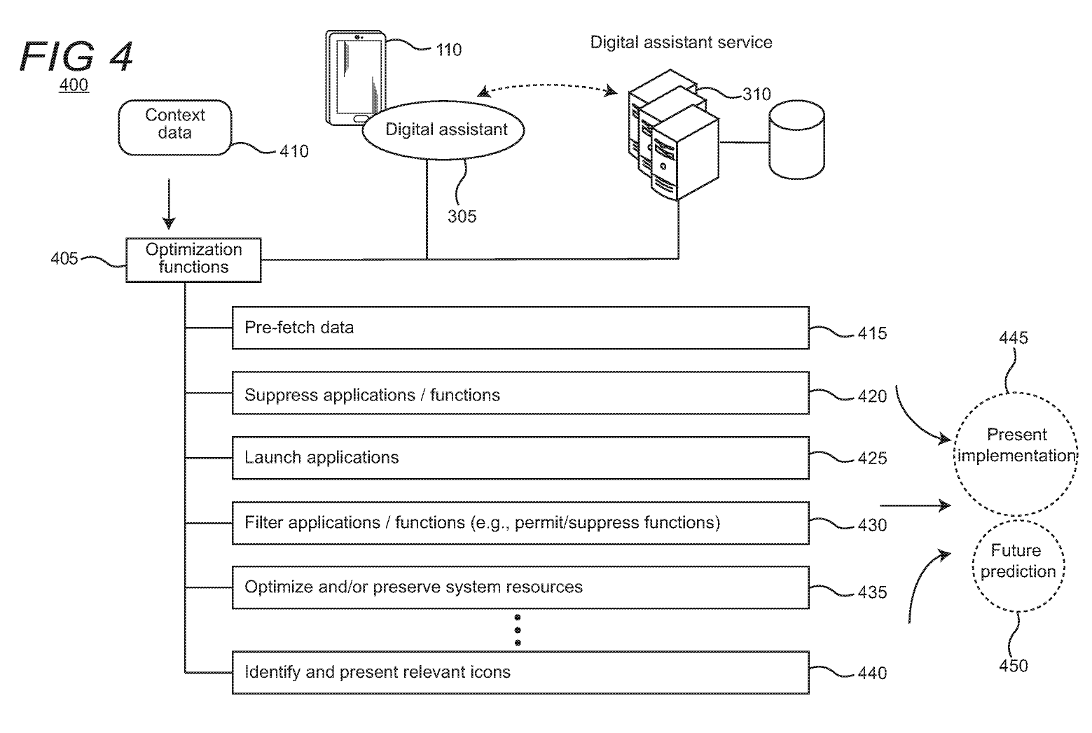

FIG. 4 shows an illustrative architecture 400 in which the optimization client of the digital assistant or optimization service performs a taxonomy of functions 405 based on context data 410. For example, based on the context data the digital assistant can pre-fetch data 415, suppress applications/functions 420, launch applications 425, filter applications/functions 430 (e.g., permit/suppress functions), optimize and/or preserve system resources 435, and identify and present relevant icons 440. The functions depicted in FIG. 4 may be performed based on future predictions 450, that is, operations that the digital assistant predicts will occur. The functions may also be implemented 445 in real time based on real-time context data.

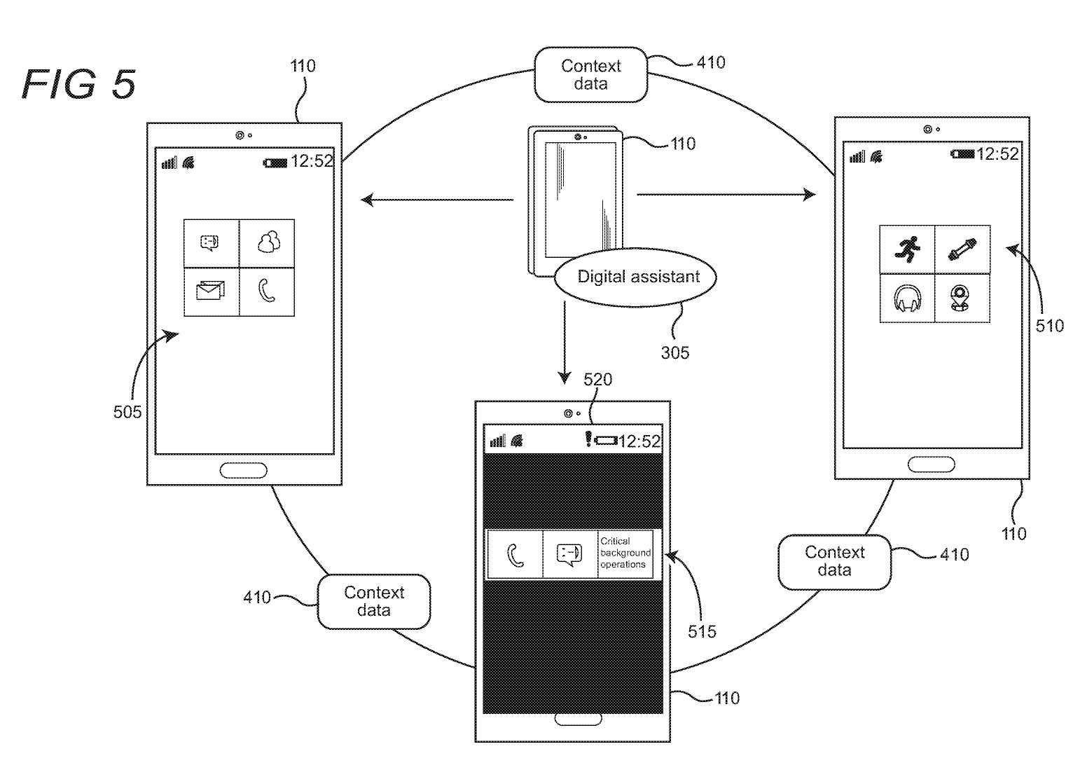

FIG. 5 shows illustrative GUI presentations in which the digital assistant identified relevant icons and system performances based on context data. In addition, after the digital assistant develops the various presentations, the developed presentations may be stored in memory for future use. The various illustrative presentations 505, 510, and 515 of FIG. 5 show different icons associated with applications that the digital assistant has selected based on the current or future predicted context. Furthermore, presentation 515 depicts changes to system performance based on the context data in addition to selecting relevant icons.

For example, in response to the low battery warning 520, the display has been dimmed/darkened to preserve battery power. Simultaneously, certain critical or relevant applications are displayed, such as the messaging and phone icons. As depicted in presentation 515, critical background operations may still be performed to operate the device. As discussed in further detail below, based on a status of system resources (e.g., a low battery scenario), the digital assistant may suppress certain programs/applications and filter certain programs/applications. These operations may be performed to prolong the device's battery life and simultaneously provide relevant applications to the user and perform useful tasks.

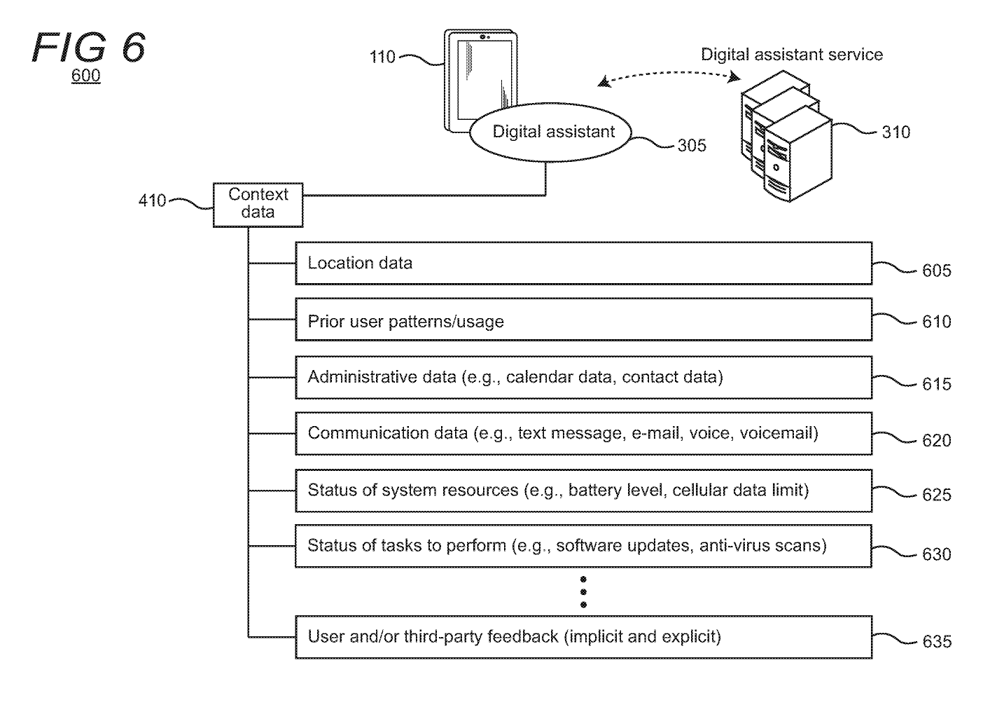

FIG. 6 provides a taxonomy 600 of context data that may be utilized by the digital assistant to determine functions that optimize the device (FIG. 4). As depicted in FIG. 6, the context data 410 can include location data 605, prior user patterns/usage 610, administrative data (e.g., calendar data, contact data) 615, communication data (e.g., text message, e-mail, voice, voicemail) 620, status of system resources (e.g., battery level, cellular data limit) 625, status of tasks to perform (e.g., software updates, anti-virus scans) 630, and one or both of user feedback or third-party feedback (implicit or explicit) 635.

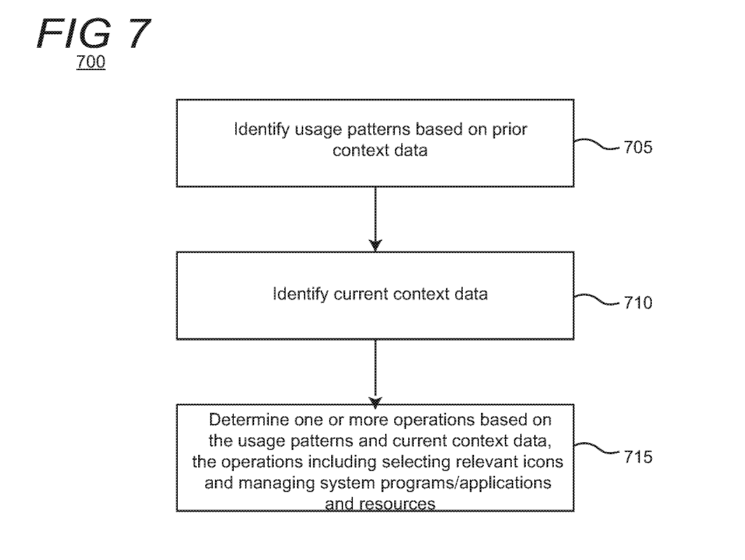

FIG. 7 shows an exemplary process performed by the digital assistant in which the digital assistant manages various operations of the device. At step 705 the digital assistant identifies, with notice to the user and user consent, usage patterns based on prior context data. For example, usage patterns may be based on applications or programs used in certain situations, such as based on location (e.g., applications used at particular locations), calendar data (e.g., applications used for certain appointments), contact data (e.g., applications used with certain individuals), etc.

At step 710 the digital assistant identifies current context data. For example, the digital assistant may analyze or monitor, with notice to the user and user consent, the context data described with respect to FIG. 6.

At step 715 the digital assistant determines one or more operations to perform based on the usage patterns (step 705) and current context data (step 710). The operations may include, for example, selecting associated icons for presentation on the display of the user's device and managing system programs, applications, and resources. These determined operations may be based on future predictions of what will occur (e.g., based on usage patterns) or present implementations (e.g., real-time updates based on real-time context data).

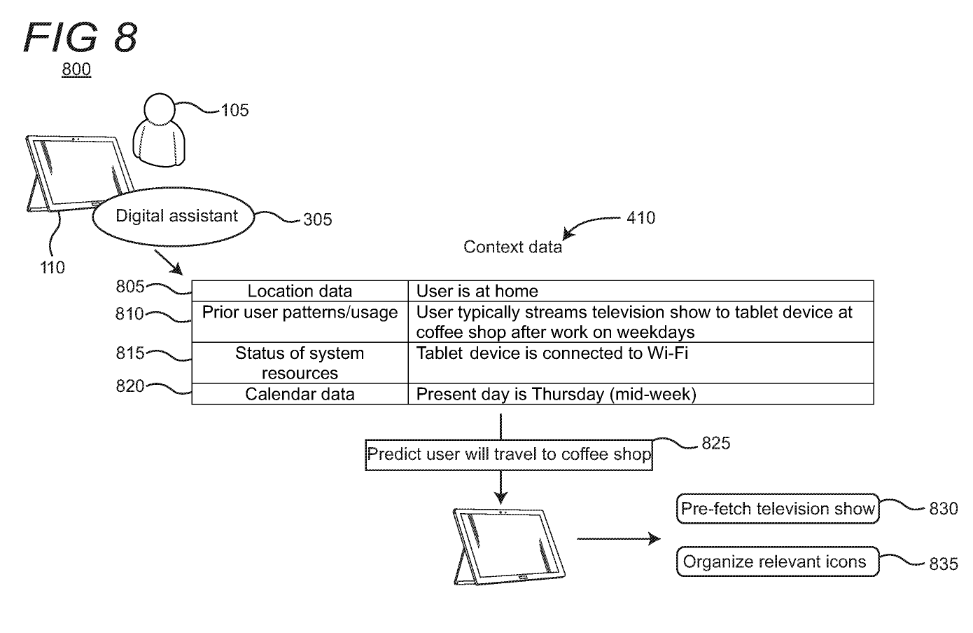

FIGS. 8-17 provide various use scenarios based on the process of FIG. 7.

FIG. 8 provides an exemplary use scenario 800 in which the digital assistant observes a portion of the context data 410 (FIG. 6) and determines various operations to perform. For example, row 805 shows that the user's location is at home; row 810 shows that the user typically streams a television show to his tablet device at a coffee shop after work on weekdays; row 815 shows that the tablet device is currently connected to Wi-Fi; and row 820 shows that it is Thursday. The digital assistant predicts that the user will travel to the coffee shop 825 in view of the previous context data (prior usage patterns at coffee shop during week) and the current context data (mid-week).

Thus, the digital assistant pre-fetches the television show 830 while connected to Wi-Fi and organizes relevant icons 835 that the user may use at the coffee shop. The digital assistant downloads the television show while the user is at home connected to Wi-Fi so that the show is ready to view upon arrival at the coffee shop. Furthermore, this avoids the possibility that the coffee shop does not have Wi-Fi, has slow connectivity due to insufficient bandwidth, etc.

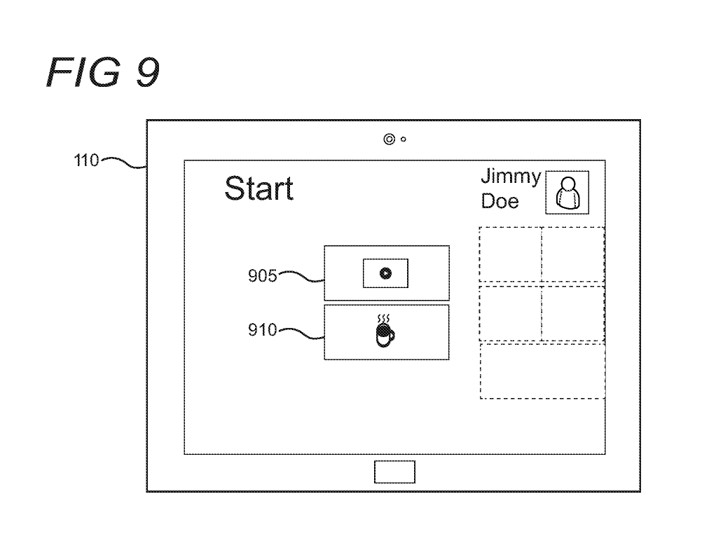

FIG. 9 shows an illustrative presentation and selection of icons relevant to the use scenario of FIG. 8. Specifically, the digital assistant selected the video application 905 and coffee application 910 (e.g., loyalty or rewards program app). This way the user can easily locate and select the icons based on the user's current situation. The presentation depicted on the device in FIG. 9 may have replaced the original GUI presentation, such as the GUI presentation customized by the user. The entire original GUI presentation may be completely or partially removed, and the new GUI presentation may be shown prominently on the display (such as in the center) so that the user can easily view and select the icons.

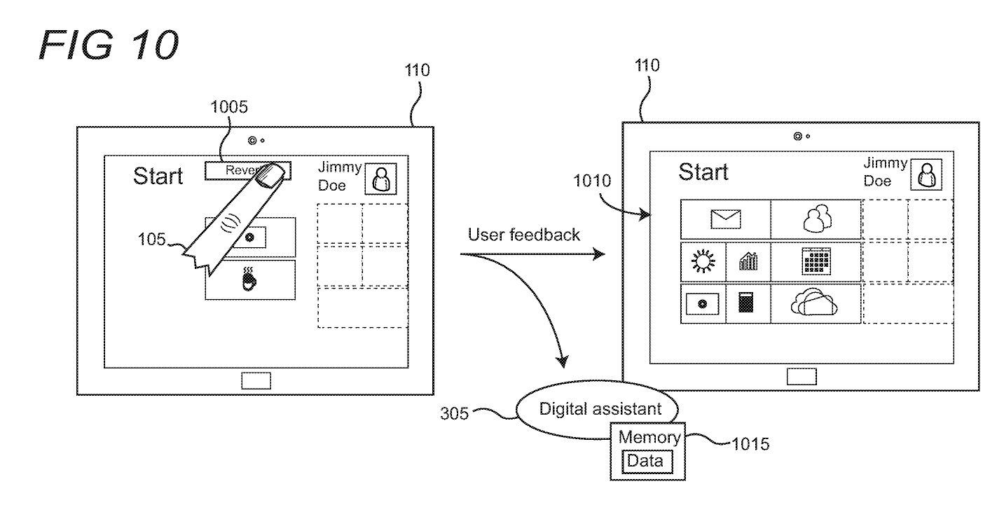

FIG. 10 shows another scenario in which a revert button (or any input mechanism) 1005 is displayed. When the user 105 selects the revert button, the selected icons presented in the new configuration may revert back to the original GUI configuration 1010 in view of the user feedback. Furthermore, the user feedback may be transmitted to the digital assistant and stored in memory 1015. For example, the digital assistant may intelligently learn from the user feedback for future operations to perform, icons to intelligently select, etc.

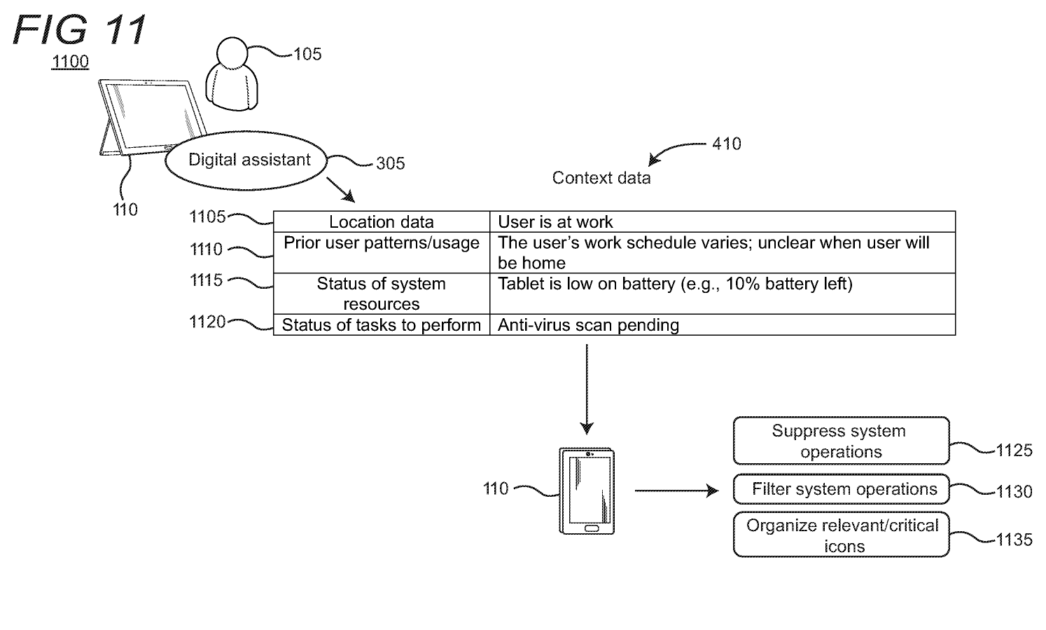

FIG. 11 shows an exemplary use scenario 1100 in which the digital assistant observes a portion of the context data 410 and determines various operations to perform. In this scenario, at row 1105 the user is at work; at row 1110 the user's work schedule varies so it is unclear when the user will be home; at row 1115 the tablet is low on battery; and at row 1120 an anti-virus scan is pending. In view of the context data, the digital assistant suppresses system operations 1125, filters system operations 1130, and organizes relevant/critical icons 1135.

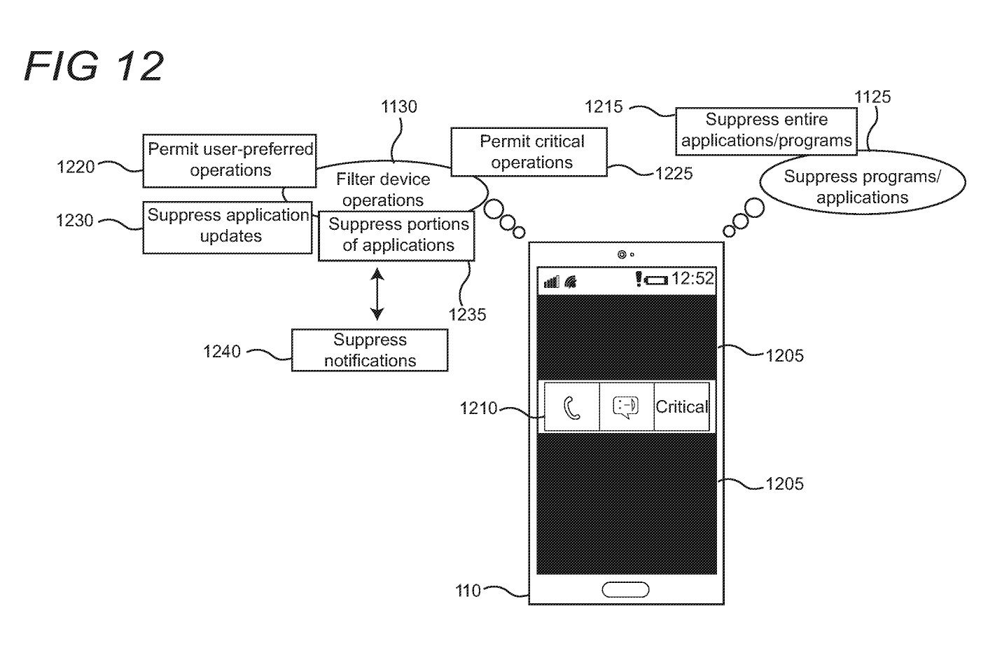

FIG. 12 shows an illustrative device 110 in view of the context data depicted in FIG. 11. For example, portions 1205 of the screen of the device are dimmed/blackened to preserve battery power. In addition, important or relevant icons 1210 are displayed in the middle of the screen so that the user, in this scenario, is still able to communicate with other parties by messenger or phone. The digital assistant may have selected the critical or relevant icons automatically, or based on user preferences, or a combination of the two.

The digital assistant adjusts various processes as well. For example, the digital assistant suppresses programs or applications 1125. This can include suppressing entire applications or programs 1215, such as non-essential or low-importance applications (e.g., weather application, social media applications, etc.).

When the digital assistant filters system operations 1130, the digital assistant may permit user-preferred operations (e.g., certain applications and programs) 1220, permit critical operations 1225, suppress application/system updates 1230, and suppress portions of applications 1235. The digital assistant can suppress a portion of an application by suppressing one or more functions associated with the application, while still permitting one or more functions to occur, such as suppress notifications 1240 (e.g., allow user to send and receive messages, but suppress notifications of incoming messages). Additional examples in which the digital assistant suppresses portions of applications can include only issue notification of incoming communication/message from selected individuals, suppress financial notifications unless notification pertains to fraud or theft on an account, disable messaging component to receive messages, disable transceiver or network component to receive signals/data from other devices or servers, etc. Furthermore, user preferences can override functions that the digital assistant selected to perform or not to perform.

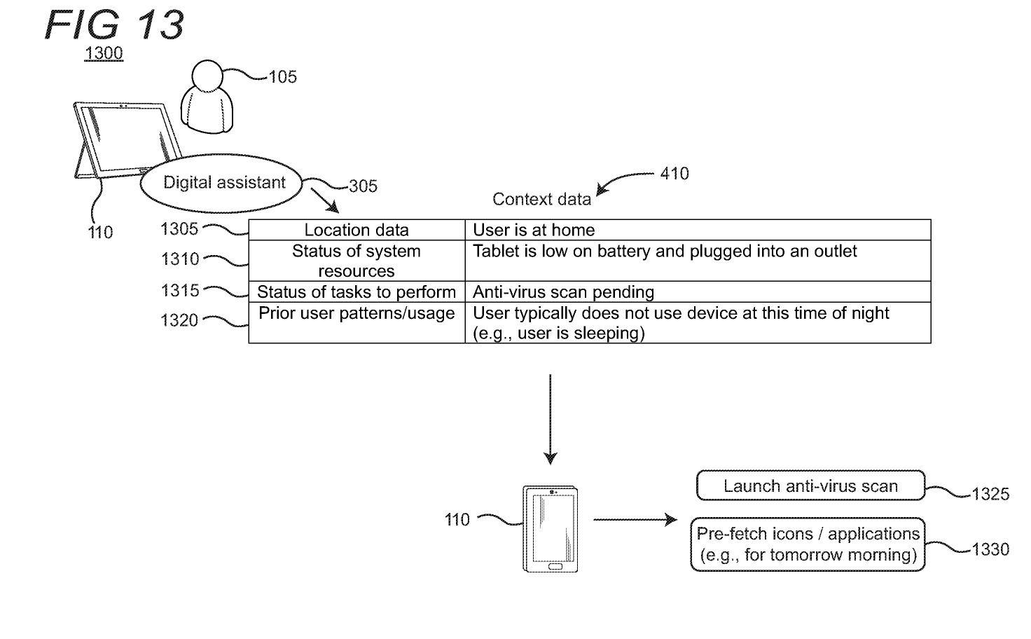

FIG. 13 shows an exemplary use scenario 1300 in which the digital assistant observes a portion of the context data 410 and determines various operations to perform. In this scenario, at row 1305 the user is at home; at row 1310 the tablet is low on battery and plugged into an outlet; at row 1315 an anti-virus scan is pending; and at row 1320 the user does not typically use the tablet device at this time. In response to the context data, the digital assistant launches the anti-virus scan 1325 since it is likely the device will continue to charge and may not be used for a while. Furthermore, the digital assistant can analyze previous context and usage data to predict applications to display for the morning and pre-fetch any data 1330.

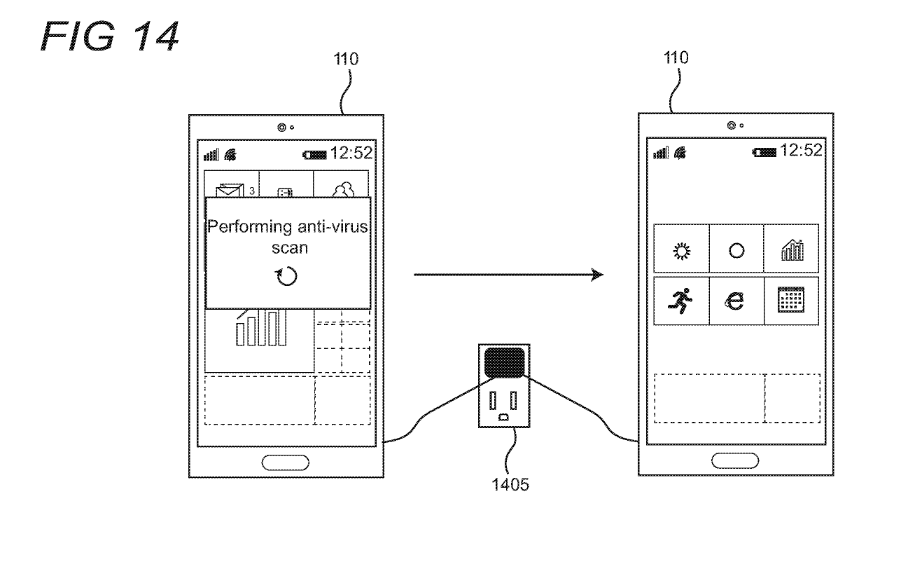

FIG. 14 shows illustrative displays of the device 110 in response to the context data observed in FIG. 13. For example, the first display shows the device performing the anti-virus scan while plugged into an outlet 1405. After, before, or simultaneously with the anti-virus scan, the digital assistant determines icons and pre-fetches data in preparation for the user's next interaction with the device. The second device portrays a group of icons selected and presented for the user based on the digital assistant's prediction.

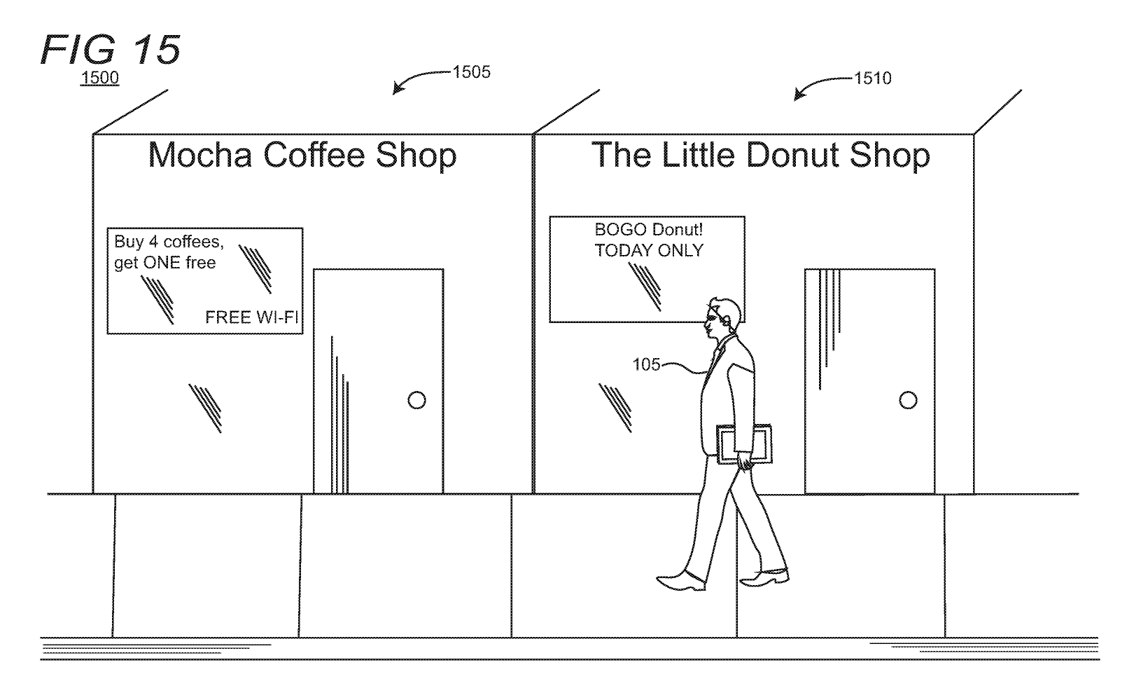

FIG. 15 shows an exemplary use scenario 1500 in which the digital assistant observes a portion of the context data 410 and determines various operations to perform. In this scenario, the user 105 walks on a sidewalk along a city street with multiple stores within the vicinity. For example, exemplary Mocha Coffee Shop 1505 and exemplary Little Donut Shop 1510 are two stores that the user passes by on his journey.

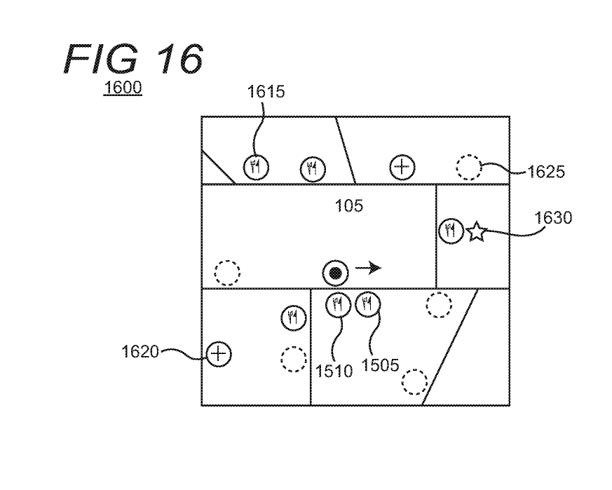

FIG. 16 provides a detailed map view 1600, not drawn to scale, of the user's journey. FIG. 16 illustrates the Mocha Coffee Shop 1505, Little Donut Shop 1510, other food establishments 1615, pharmacy stores 1620, and other stores represented by random graphic 1625. When the user walks down the street, the digital assistant can determine relevant applications associated with the various establishments. For example, when the user is walking toward the Mocha Coffee Shop 1505 and/or the Little Donut Shop 1510, the digital assistant can identify a loyalty app stored in the user's phone and accordingly display that application.

FIG. 16 shows a star 1630 that represents one of the user's friends. The digital assistant may have access to the friend's location when the friend and user receive notice and provide consent to share location data with each other. The digital assistant may have identified that the friend is associated with the user based on various context data, such as the friend's information being stored in contact data, communication data (e.g., messages, e-mails, phone calls, etc. between the user and the friend), or a combination of the two. Thus, when the digital assistant determines or infers that the user may accompany the friend 1630 at that establishment, the digital assistant may identify an application associated with the establishment where the friend is located.

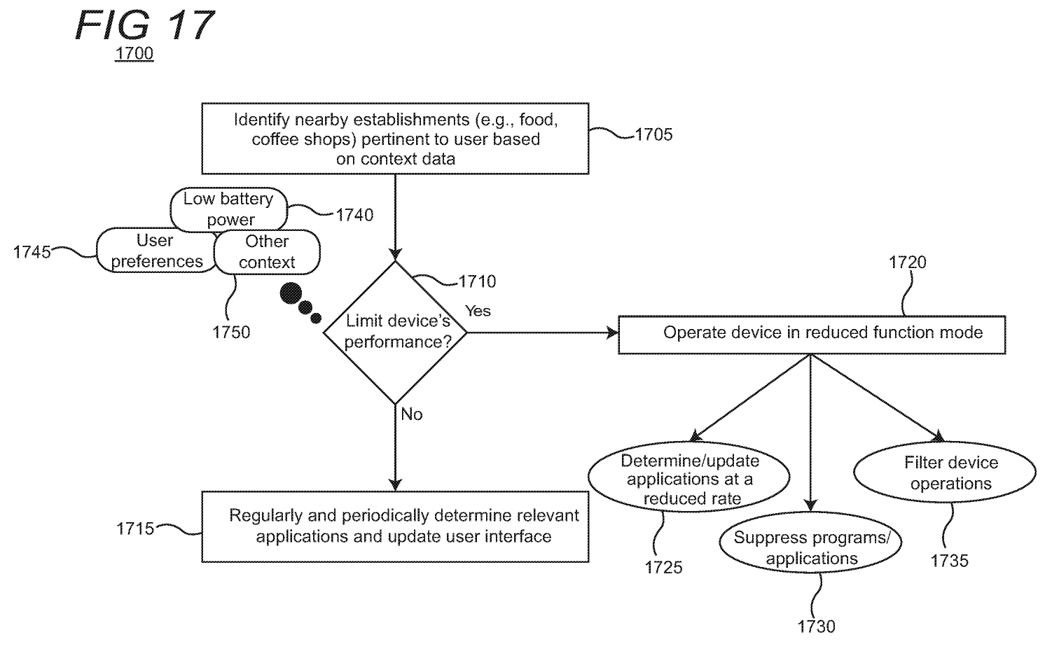

FIG. 17 provides a process 1700 that the digital assistant performs based on the scenario illustrated in FIGS. 15 and 16. FIG. 17 deals with the situation in which, as the user continues to travel (e.g., walk, drive, bike) along the street, the digital assistant may perform resource-intensive operations to identify numerous stores/establishments nearby and directly or indirectly associated with the user, such as through the various tracked context data. Thus, the digital assistant may constantly and periodically determine or infer connections or associations between establishments or landmarks and the user. These connections or associations may be based on names of establishments or landmarks mentioned in communications, a user's search history, associations with calendar data, associations with contact data, and the like. Therefore, based on the context, the digital assistant may find it prudent to perform, not to perform, or reduce the rate of performance of these resource-intensive tasks, such as in congested areas.

At step 1705 the digital assistant identifies nearby establishments (e.g., food, coffee shops) pertinent to the user based on context data. For example, the digital assistant may make associations based on contacts that are nearby, meeting places set up in the calendar, establishments that the user has visited previously, such as a threshold number of times, etc. Therefore, the digital assistant utilizes the context data personal to the user, applies the context data to the user's current contextual situation, and makes predictions. The digital assistant makes comparisons between prior usage, present usage, present location, and predicted future usage to make the most coherent prediction.

At step 1710 the digital assistant determines whether or not to limit the device's performance or functionality. This may occur, for example, based on system capabilities such as low battery 1740, user preferences 1745, or other context 1750. If the digital assistant determines not to limit the device's performance, then the digital assistant may regularly and periodically determine relevant applications and update user interface 1715 as the user continues to travel along the street.

If the digital assistant determines to limit the device's performance or functionality (e.g., to preserve battery life), the device may function in a reduced function mode at step 1720. In the reduced function mode, there may be one or more functions that the device can perform. For example, the device may reduce or stop updating the user interface (e.g., with relevant icons) 1725, suppress programs/applications 1730, or filter device operations 1735.

In this scenario, the digital assistant may filter applications that are more relevant relative to other applications. For example, there may be insufficient reason to cause the digital assistant to place an icon on the display in the reduced operation mode for an establishment that the user has previously frequented. However, in the scenario in FIG. 16 where the friend 1630 is at the establishment, this may cause a heightened threshold under the reduced operation mode to be satisfied for the establishment, and thereby show (if available) the associated application or website on the display.

The user may not want the device to continuously update icons on the display while walking on a business-congested street. Thus, the user may set preferences in the reduced operation mode to reduce the rate at which the digital assistant determines relevant applications and updates the display, regardless of the status of the system's capabilities.

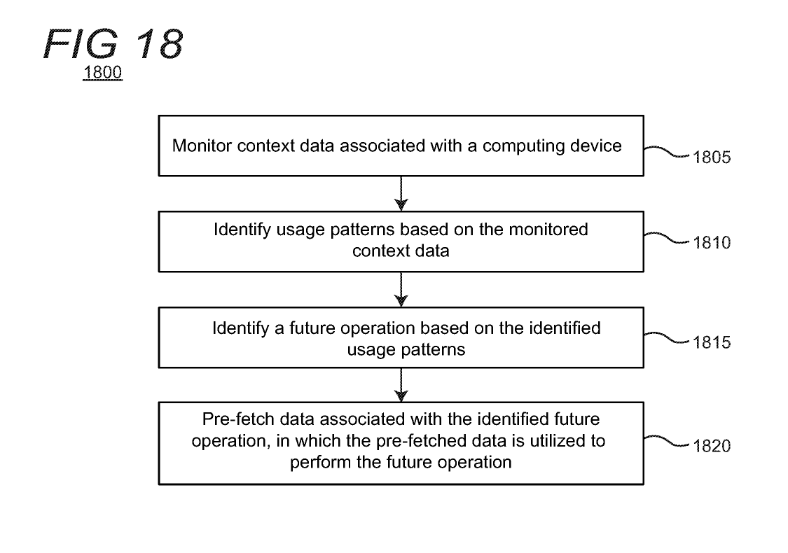

FIG. 18 is a flowchart of an illustrative method 1800 to dynamically update graphic elements on a graphical user interface (GUI) of a computing device. Unless specifically stated, methods or steps shown in the flowcharts and described in the accompanying text are not constrained to a particular order or sequence. In addition, some of the methods or steps thereof can occur or be performed concurrently and not all the methods or steps have to be performed in a given implementation depending on the requirements of such implementation and some methods or steps may be optionally utilized.

In step 1805, context data that is associated with a computing device is monitored. In step 1810, usage patterns that are based on the monitored context data are identified. In step 1815, a future operation is identified, in which the future operation is based on the identified usage patterns. In step 1820, data that is associated with the identified future operation is pre-fetched, such that the pre-fetched data is utilized to perform the future operation.

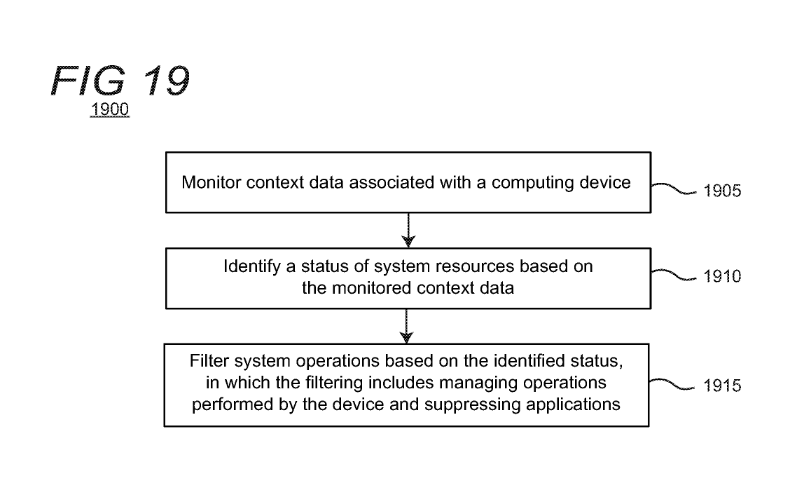

FIG. 19 is a flowchart of an illustrative method 1900 that may be performed by the computing device, such as a mobile device, in which a virtual digital assistant is instantiated on the computing device. In step 1905, context data may be monitored by the computing device, such as by the digital assistant. In step 1910, a status of system resources based on the monitored context data may be identified. In step 1915, system operations may be filtered based on the identified status. The filtering can include managing operations performed by the computing device, suppressing applications, and suppressing sub-parts of applications.

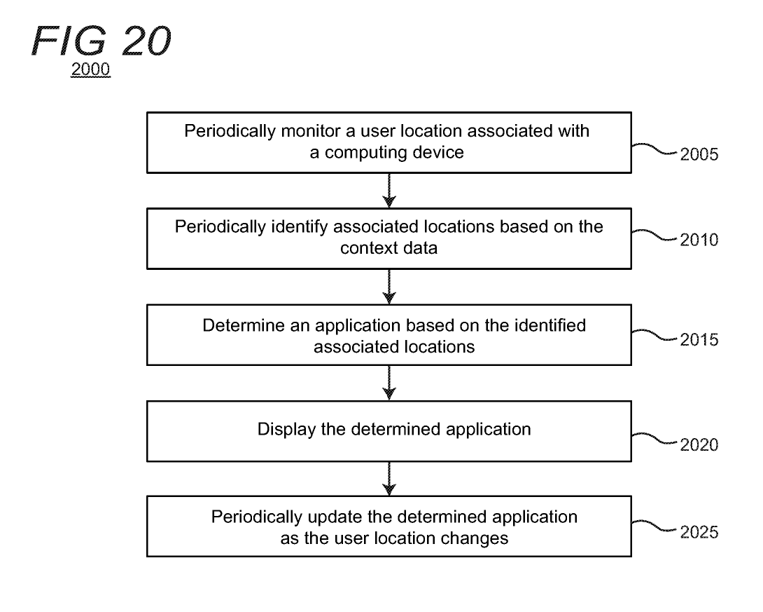

FIG. 20 is another flowchart of an illustrative method 2000 that may be performed by the computing device. In step 2005, a user's location may be periodically monitored using the computing device. In step 2010, associated locations may be periodically identified based on context data. For example, the associated locations can be based on the monitored user location of the computing device being within a threshold distance to the associated location. In step 2015, an application can be determined based on the identified associated locations. In step 2020, the determined application is displayed on the computing device. Finally, in step 2025 the determined application periodically updates as the user's location continues to change.

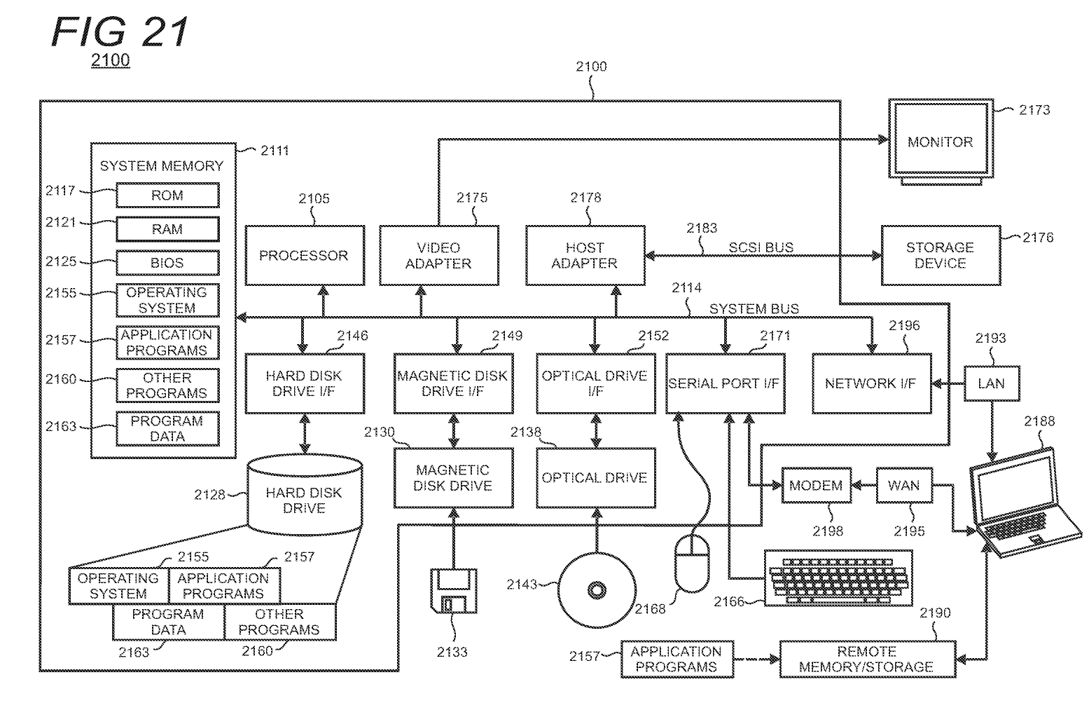

FIG. 21 is a simplified block diagram of an illustrative computer system 2100 such as a PC, client machine, or server with which the present contextual experience based on location is utilized. Computer system 2100 includes a processor 2105, a system memory 2111, and a system bus 2114 that couples various system components including the system memory 2111 to the processor 2105. The system bus 2114 may be any of several types of bus structures including a memory bus or memory controller, a peripheral bus, or a local bus using any of a variety of bus architectures. The system memory 2111 includes read only memory (ROM) 2117 and random access memory (RAM) 2121. A basic input/output system (BIOS) 2125, containing the basic routines that help to transfer information between elements within the computer system 2100, such as during startup, is stored in ROM 2117. The computer system 2100 may further include a hard disk drive 2128 for reading from and writing to an internally disposed hard disk (not shown), a magnetic disk drive 2130 for reading from or writing to a removable magnetic disk 2133 (e.g., a floppy disk), and an optical disk drive 2138 for reading from or writing to a removable optical disk 2143 such as a CD (compact disc), DVD (digital versatile disc), or other optical media. The hard disk drive 2128, magnetic disk drive 2130, and optical disk drive 2138 are connected to the system bus 2114 by a hard disk drive interface 2146, a magnetic disk drive interface 2149, and an optical drive interface 2152, respectively. The drives and their associated computer-readable storage media provide non-volatile storage of computer-readable instructions, data structures, program modules, and other data for the computer system 2100. Although this illustrative example includes a hard disk, a removable magnetic disk 2133, and a removable optical disk 2143, other types of computer-readable storage media which can store data that is accessible by a computer such as magnetic cassettes, Flash memory cards, digital video disks, data cartridges, random access memories (RAMs), read only memories (ROMs), and the like may also be used in some applications of the present contextual experience based on location. In addition, as used herein, the term computer-readable storage media includes one or more instances of a media type (e.g., one or more magnetic disks, one or more CDs, etc.). For purposes of this specification and the claims, the phrase “computer-readable storage media” and variations thereof, does not include waves, signals, and/or other transitory and/or intangible communication media.

A number of program modules may be stored on the hard disk 2128, magnetic disk 2130, optical disk 2138, ROM 2117, or RAM 2121, including an operating system 2155, one or more application programs 2157, other program modules 2160, and program data 2163. A user may enter commands and information into the computer system 2100 through input devices such as a keyboard 2166 and pointing device 2168 such as a mouse. Other input devices (not shown) may include a microphone, joystick, game pad, satellite dish, scanner, trackball, touchpad, touchscreen, touch-sensitive device, voice-command module or device, user motion or user gesture capture device, or the like. These and other input devices are often connected to the processor 2105 through a serial port interface 2171 that is coupled to the system bus 2114, but may be connected by other interfaces, such as a parallel port, game port, or universal serial bus (USB). A monitor 2173 or other type of display device is also connected to the system bus 2114 via an interface, such as a video adapter 2175. In addition to the monitor 2173, personal computers typically include other peripheral output devices (not shown), such as speakers and printers. The illustrative example shown in FIG. 21 also includes a host adapter 2178, a Small Computer System Interface (SCSI) bus 2183, and an external storage device 2176 connected to the SCSI bus 2183.

The computer system 2100 is operable in a networked environment using logical connections to one or more remote computers, such as a remote computer 2188. The remote computer 2188 may be selected as another personal computer, a server, a router, a network PC, a peer device, or other common network node, and typically includes many or all of the elements described above relative to the computer system 2100, although only a single representative remote memory/storage device 2190 is shown in FIG. 21. The logical connections depicted in FIG. 21 include a local area network (LAN) 2193 and a wide area network (WAN) 2195. Such networking environments are often deployed, for example, in offices, enterprise-wide computer networks, intranets, and the Internet.

When used in a LAN networking environment, the computer system 2100 is connected to the local area network 2193 through a network interface or adapter 2196. When used in a WAN networking environment, the computer system 2100 typically includes a broadband modem 2198, network gateway, or other means for establishing communications over the wide area network 2195, such as the Internet. The broadband modem 2198, which may be internal or external, is connected to the system bus 2114 via a serial port interface 2171. In a networked environment, program modules related to the computer system 2100, or portions thereof, may be stored in the remote memory storage device 2190. It is noted that the network connections shown in FIG. 21 are illustrative and other methods of establishing a communications link between the computers may be used depending on the specific requirements of an application of the present contextual experience based on location.

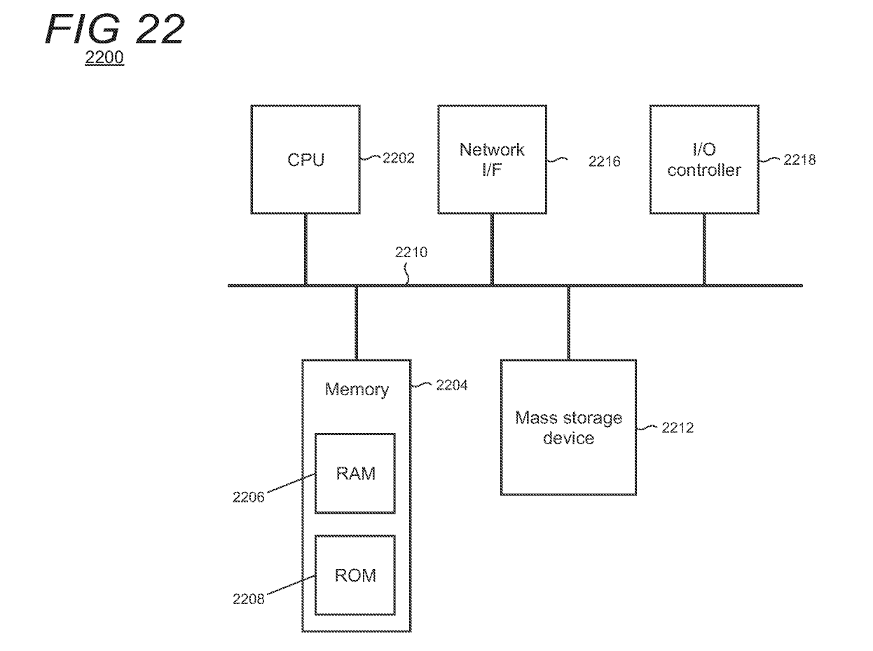

FIG. 22 shows an illustrative architecture 2200 for a device capable of executing the various components described herein for providing a contextual experience based on location. Thus, the architecture 2200 illustrated in FIG. 22 shows an architecture that may be adapted for a server computer, mobile phone, a PDA, a smartphone, a desktop computer, a netbook computer, a tablet computer, GPS device, gaming console, and/or a laptop computer. The architecture 2200 may be utilized to execute any aspect of the components presented herein.

The architecture 2200 illustrated in FIG. 22 includes a CPU (Central Processing Unit) 2202, a system memory 2204, including a RAM 2206 and a ROM 2208, and a system bus 2210 that couples the memory 2204 to the CPU 2202. A basic input/output system containing the basic routines that help to transfer information between elements within the architecture 2200, such as during startup, is stored in the ROM 2208. The architecture 2200 further includes a mass storage device 2212 for storing software code or other computer-executed code that is utilized to implement applications, the file system, and the operating system.

The mass storage device 2212 is connected to the CPU 2202 through a mass storage controller (not shown) connected to the bus 2210.The mass storage device 2212 and its associated computer-readable storage media provide non-volatile storage for the architecture 2200.

Although the description of computer-readable storage media contained herein refers to a mass storage device, such as a hard disk or CD-ROM drive, it may be appreciated by those skilled in the art that computer-readable storage media can be any available storage media that can be accessed by the architecture 2200.

By way of example, and not limitation, computer-readable storage media may include volatile and non-volatile, removable and non-removable media implemented in any method or technology for storage of information such as computer-readable instructions, data structures, program modules, or other data. For example, computer-readable media includes, but is not limited to, RAM, ROM, EPROM (erasable programmable read only memory), EEPROM (electrically erasable programmable read only memory), Flash memory or other solid state memory technology, CD-ROM, DVDs, HD-DVD (High Definition DVD), Blu-ray, or other optical storage, magnetic cassettes, magnetic tape, magnetic disk storage or other magnetic storage devices, or any other medium which can be used to store the desired information and which can be accessed by the architecture 2200.

According to various embodiments, the architecture 2200 may operate in a networked environment using logical connections to remote computers through a network. The architecture 2200 may connect to the network through a network interface unit 2216 connected to the bus 2210. It may be appreciated that the network interface unit 2216 also may be utilized to connect to other types of networks and remote computer systems. The architecture 2200 also may include an input/output controller 2218 for receiving and processing input from a number of other devices, including a keyboard, mouse, or electronic stylus (not shown in FIG. 22). Similarly, the input/output controller 2218 may provide output to a display screen, a printer, or other type of output device (also not shown in FIG. 22).

It may be appreciated that the software components described herein may, when loaded into the CPU 2202 and executed, transform the CPU 2202 and the overall architecture 2200 from a general-purpose computing system into a special-purpose computing system customized to facilitate the functionality presented herein. The CPU 2202 may be constructed from any number of transistors or other discrete circuit elements, which may individually or collectively assume any number of states. More specifically, the CPU 2202 may operate as a finite-state machine, in response to executable instructions contained within the software modules disclosed herein. These computer-executable instructions may transform the CPU 2202 by specifying how the CPU 2202 transitions between states, thereby transforming the transistors or other discrete hardware elements constituting the CPU 2202.

Encoding the software modules presented herein also may transform the physical structure of the computer-readable storage media presented herein. The specific transformation of physical structure may depend on various factors, in different implementations of this description. Examples of such factors may include, but are not limited to, the technology used to implement the computer-readable storage media, whether the computer-readable storage media is characterized as primary or secondary storage, and the like. For example, if the computer-readable storage media is implemented as semiconductor-based memory, the software disclosed herein may be encoded on the computer-readable storage media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable storage media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media to change the optical characteristics of those locations. Other transformations of physical media are possible without departing from the scope and spirit of the present description, with the foregoing examples provided only to facilitate this discussion.

In light of the above, it may be appreciated that many types of physical transformations take place in the architecture 2200 in order to store and execute the software components presented herein. It also may be appreciated that the architecture 2200 may include other types of computing devices, including handheld computers, embedded computer systems, smartphones, PDAs, and other types of computing devices known to those skilled in the art. It is also contemplated that the architecture 2200 may not include all of the components shown in FIG. 22, may include other components that are not explicitly shown in FIG. 22, or may utilize an architecture completely different from that shown in FIG. 22.

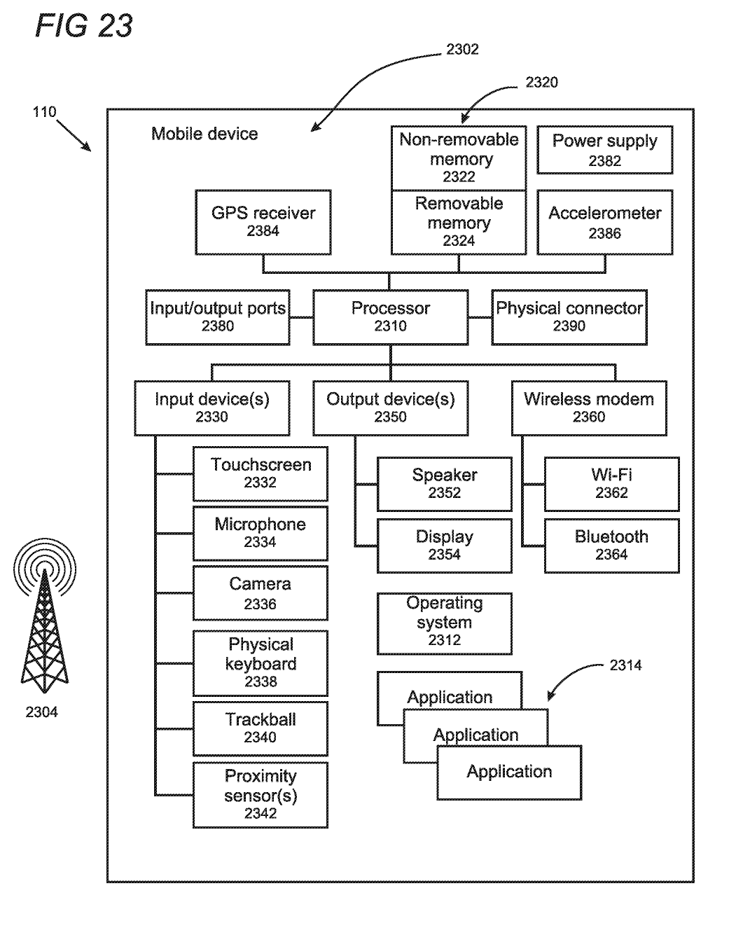

FIG. 23 is a functional block diagram of an illustrative device 110 such as a mobile phone or smartphone including a variety of optional hardware and software components, shown generally at 2302. Any component 2302 in the mobile device can communicate with any other component, although, for ease of illustration, not all connections are shown. The mobile device can be any of a variety of computing devices (e.g., cell phone, smartphone, handheld computer, PDA, etc.) and can allow wireless two-way communications with one or more mobile communication networks 2304, such as a cellular or satellite network.

The illustrated device 110 can include a controller or processor 2310 (e.g., signal processor, microprocessor, microcontroller, ASIC (Application Specific Integrated Circuit), or other control and processing logic circuitry) for performing such tasks as signal coding, data processing, input/output processing, power control, and/or other functions. An operating system 2312 can control the allocation and usage of the components 2302, including power states, above-lock states, and below-lock states, and provides support for one or more application programs 2314. The application programs can include common mobile computing applications (e.g., image-capture applications, email applications, calendars, contact managers, web browsers, messaging applications), or any other computing application.

The illustrated device 110 can include memory 2320. Memory 2320 can include non-removable memory 2322 and/or removable memory 2324. The non-removable memory 2322 can include RAM, ROM, Flash memory, a hard disk, or other well-known memory storage technologies. The removable memory 2324 can include Flash memory or a Subscriber Identity Module (SIM) card, which is well known in GSM (Global System for Mobile communications) systems, or other well-known memory storage technologies, such as “smart cards.” The memory 2320 can be used for storing data and/or code for running the operating system 2312 and the application programs 2314. Example data can include web pages, text, images, sound files, video data, or other data sets to be sent to and/or received from one or more network servers or other devices via one or more wired or wireless networks.

The memory 2320 may also be arranged as, or include, one or more computer-readable storage media implemented in any method or technology for storage of information such as computer-readable instructions, data structures, program modules or other data. For example, computer-readable media includes, but is not limited to, RAM, ROM, EPROM, EEPROM, Flash memory or other solid state memory technology, CD-ROM (compact-disc ROM), DVD, (Digital Versatile Disc) HD-DVD (High Definition DVD), Blu-ray, or other optical storage, magnetic cassettes, magnetic tape, magnetic disk storage or other magnetic storage devices, or any other medium which can be used to store the desired information and which can be accessed by the device 110.

The memory 2320 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment. The device 110 can support one or more input devices 2330—such as a touchscreen 2332; microphone 2334 for implementation of voice input for voice recognition, voice commands and the like; camera 2336; physical keyboard 2338; trackball 2340; and/or proximity sensor 2342; and one or more output devices 2350—such as a speaker 2352 and one or more displays 2354. Other input devices (not shown) using gesture recognition may also be utilized in some cases. Other possible output devices (not shown) can include piezoelectric or haptic output devices. Some devices can serve more than one input/output function. For example, touchscreen 2332 and display 2354 can be combined into a single input/output device.

A wireless modem 2360 can be coupled to an antenna (not shown) and can support two-way communications between the processor 2310 and external devices, as is well understood in the art. The modem 2360 is shown generically and can include a cellular modem for communicating with the mobile communication network 2304 and/or other radio-based modems (e.g., Bluetooth® 2364 or Wi-Fi 2362). The wireless modem 2360 is typically configured for communication with one or more cellular networks, such as a GSM network for data and voice communications within a single cellular network, between cellular networks, or between the device and a public switched telephone network (PSTN).

The device can further include at least one input/output port 2380, a power supply 2382, a satellite navigation system receiver 2384, such as a GPS receiver, an accelerometer 2386, a gyroscope (not shown), and/or a physical connector 2390, which can be a USB port, IEEE 1394 (FireWire) port, and/or an RS-232 port. The illustrated components 2302 are not required or all-inclusive, as any components can be deleted and other components can be added.

Various exemplary embodiments of the present contextual experience based on location are now presented by way of illustration and not as an exhaustive list of all embodiments. An example includes a method to dynamically update graphic elements on a graphical user interface (GUI) of a computing device, comprising: monitoring context data associated with the computing device; identifying usage patterns of the computing device based on the monitored context data; identifying a future operation based on the identified usage patterns, wherein the future operation is predicted to occur based on the usage patterns; pre-fetching data associated with the identified future operation, wherein the pre-fetched data is utilized for the computing device to execute the future operation.

In another example, the pre-fetched data includes one or more of data associated with music, audio, movie, television, video, or image. In another example, additional context data includes one or more of location data, contact data, communication data, status of system resources, status of tasks to perform, user feedback, or third-party feedback, and the identified future operation is further based on one or more of the additional context data. In another example, the method further comprises: predicting one or more applications for future use based on the usage patterns; and replacing a previous GUI configuration with graphical elements associated with the one or more predicted applications, wherein the replacing includes re-configuring the GUI to add graphical elements associated with the predicted one or more applications. In another example, the predicting is based on the one or more applications being used at or about a location a threshold number of times. In another example, the identified future operation is based on the one or more applications being used at the location the threshold number of times, and the pre-fetched data for the future operation is associated with the one or more applications. In another example, the predicting is further based on user feedback to a previously presented GUI based on the prediction. In another example, the method further comprises filtering functions performed by the device based on the identified future operation, wherein the device filters functions by one or both of suppressing an aspect of a program or permitting an aspect of the program.

A further example includes a device, comprising: one or more processors; one or more hardware-based memory devices storing a plurality of applications and exposing a digital assistant, and further storing computer-readable instructions which, when executed by the one or more processors cause the computing device to: monitor context data associated with the device; identify a status of system resources based on the monitored context data; and filter system operations based on the identified status, wherein the filtering includes managing operations performed by the device, wherein the managing includes suppressing entire applications and suppressing sub-parts of applications.

In another example, the status of system resources includes one or more of battery life or tasks to be performed by the device. In another example, the tasks to be performed include one or more of system updates, application updates, or anti-virus scans. In another example, the suppressing includes one or more of not accepting signals or messages from other devices, not providing a notification of an incoming message, not providing a notification of an update, or not performing a function associated with an application. In another example, the filtering includes: selecting which functions associated with the device to perform and not to perform; permitting performance of the functions selected to perform; and suppressing performance of the functions selected not to perform. In another example, the device further comprises: receiving preferences from a user; and overriding the selected functions to perform and not to perform based on the received preferences. In another example, the device further comprises: selectively dimming portions of a display of the device when the status of system resources indicates to preserve battery resources; and determining relevant graphical elements based on the context data; and displaying the determined relevant graphical elements.

A further example includes one or more hardware-based computer-readable memory devices storing instructions which, when executed by one or more processors disposed in a computing device, cause the computing device to: periodically monitor a user location associated with the computing device; periodically identify associated locations based on context data, wherein the associated locations are based on the monitored user location of the computing device being within a threshold distance to the associated locations; determine an application based on the identified associated locations; display the determined application; and periodically update the determined application as the user location changes.

In another example, the instructions further cause the computing device to monitor context data associated with the computing device, and the associated locations are associated with context data of the computing device. In another example, the instructions further cause the computing device to: determine, based on context data, whether to limit performance of the computing device; and when the determination indicates to limit performance, then operate the computing device in a reduced function mode. In another example, the reduced function mode includes periodically determining and updating the application at a reduced rate. In another example, the reduced function mode includes suppressing actions of the computing device and filtering functions of the computing device.

The subject matter described above is provided by way of illustration only and is not to be construed as limiting. Various modifications and changes may be made to the subject matter described herein without following the example embodiments and applications illustrated and described, and without departing from the true spirit and scope of the present invention, which is set forth in the following claims.

What is claimed:

1. A method to dynamically update graphic elements on a graphical user interface (GUI) of a computing device, comprising:
monitoring context data associated with the computing device;
identifying usage patterns of the computing device based on the monitored context data;
identifying a future operation based on the identified usage patterns, wherein the future operation is predicted to occur based on the usage patterns;
pre-fetching data associated with the identified future operation, wherein the pre-fetched data is utilized for the computing device to execute the future operation.

2. The method of claim 1, wherein the pre-fetched data includes one or more of data associated with music, audio, movie, television, video, or image.

3. The method of claim 1, wherein additional context data includes one or more of location data, contact data, communication data, status of system resources, status of tasks to perform, user feedback, or third-party feedback, and
wherein the identified future operation is further based on one or more of the additional context data.

4. The method of claim 1, further comprising:
predicting one or more applications for future use based on the usage patterns; and
replacing a previous GUI configuration with graphical elements associated with the one or more predicted applications, wherein the replacing includes re-configuring the GUI to add graphical elements associated with the predicted one or more applications.

5. The method of claim 4, wherein the predicting is based on the one or more applications being used at or about a location a threshold number of times.

6. The method of claim 5, wherein the identified future operation is based on the one or more applications being used at the location the threshold number of times, and the pre-fetched data for the future operation is associated with the one or more applications.

7. The method of claim 5, wherein the predicting is further based on user feedback to a previously presented GUI based on the prediction.

8. The method of claim 1, further comprising filtering functions performed by the device based on the identified future operation, wherein the device filters functions by one or both of suppressing an aspect of a program or permitting an aspect of the program.

9. A device, comprising:
one or more processors;
one or more hardware-based memory devices storing a plurality of applications and exposing a digital assistant, and further storing computer-readable instructions which, when executed by the one or more processors cause the device to:
monitor context data associated with the device;
identify a status of system resources based on the monitored context data; and
filter system operations based on the identified status, wherein the filtering includes managing operations performed by the device, wherein the managing includes suppressing entire applications and suppressing sub-parts of applications.

10. The device of claim 9, wherein the status of system resources includes one or more of battery life or tasks to be performed by the device.

11. The device of claim 10, wherein the tasks to be performed include one or more of system updates, application updates, or anti-virus scans.

12. The device of claim 9, wherein the suppressing includes one or more of not accepting signals or messages from other devices, not providing a notification of an incoming message, not providing a notification of an update, or not performing a function associated with an application.

13. The device of claim 9, wherein the filtering includes:
selecting which functions associated with the device to perform and not to perform;
permitting performance of the functions selected to perform; and
suppressing performance of the functions selected not to perform.

14. The device of claim 13, further comprising:
receiving preferences from a user; and
overriding the selected functions to perform and not to perform based on the received preferences.

15. The device of claim 9, further comprising:
selectively dimming portions of a display of the device when the status of system resources indicates to preserve battery resources; and
determining relevant graphical elements based on the context data; and
displaying the determined relevant graphical elements.

16. One or more hardware-based computer-readable memory devices storing instructions which, when executed by one or more processors disposed in a computing device, cause the computing device to:
periodically monitor a user location associated with the computing device;
periodically identify associated locations based on context data, wherein the associated locations are based on the monitored user location of the computing device being within a threshold distance to the associated locations;
determine an application based on the identified associated locations;
display the determined application; and
periodically update the determined application as the user location changes.

17. The one or more hardware-based computer-readable memory devices of claim 16, wherein the instructions further cause the computing device to monitor context data associated with the computing device, and
wherein the associated locations are associated with context data of the computing device.

18. The one or more hardware-based computer-readable memory devices of claim 16, wherein the instructions further cause the computing device to:
determine, based on context data, whether to limit performance of the computing device; and
when the determination indicates to limit performance, then operate the computing device in a reduced function mode.

19. The one or more hardware-based computer-readable memory devices of claim 18, wherein the reduced function mode includes periodically determining and updating the application at a reduced rate.

20. The one or more hardware-based computer-readable memory devices of claim 18, wherein the reduced function mode includes suppressing actions of the computing device and filtering functions of the computing device.
